(19) United States
(12) Patent Application Publication
(10) Pub. No.: US 2026/0019808 A1
(43) Pub. Date: Jan. 15, 2026

(54) DIAGNOSIS EXCHANGE PROTOCOLS

(71) Applicant: Cisco Technology, Inc., San Jose, CA (US)

(72) Inventors: Javier I. CONTRERAS ALBESA, Sant Cugat del Valles (ES); Jerome HENRY, Pittsboro, NC (US); Stephen M. ORR, Wallkill, NY (US); Domenico FICARA, Essertines-Sur-Yverdon (CH); Brian D. HART, Sunnyvale, CA (US)

(21) Appl. No.: 19/268,501

(22) Filed: Jul. 14, 2025

Related U.S. Application Data
(60) Provisional application No. 63/670,516, filed on Jul. 12, 2024.

(51) Int. Cl. H04W 12/06; H04W 8/24; H04W 12/041

(52) U.S. Cl. CPC H04W 12/06; H04W 8/24; H04W 12/041

(57) ABSTRACT

Techniques are described for securely transmitting diagnostic data between a STA and an AP before the STA has successfully been on boarded at the AP. In the embodiments herein, the STA can use a key (e.g., a long-term key) to encrypt diagnostic data transmitted to the AP when the STA has not been on boarded by the AP. This key can be provided to the STA several different ways such as when the STA was provisioned to connect to a service set identifier (SSID) supported by the AP, or the STA may have previously associated with the SSID (e.g., by connecting to the same or another AP supporting the SSID during a previous session) and received or generated the key.

### CROSS-REFERENCE TO RELATED APPLICATIONS

This application claims benefit of co-pending U.S. provisional patent application Ser. No. 63/670,516 filed Jul. 12, 2024. The aforementioned related patent application is herein incorporated by reference in its entirety.

### TECHNICAL FIELD

Embodiments presented in this disclosure generally relate to exchanging encrypted diagnostic data between a station (STA) and an access point (AP).

### BACKGROUND

Wi-Fi issues are becoming increasingly harder to solve. The wide variety of protocols, either mandatory or optional, used in isolation or in combination, means issues can occur on the STA-side or the AP-side, be difficult to reproduce, and difficult to analyze. Additionally, with the proliferation of IoT devices, it becomes more difficult to obtain information regarding data connection failures. It is common for a STA to be able to connect to one AP of an Enterprise deployment but then be unable to later connect to another AP of that same deployment. From the AP perspective, the STA suddenly fails the extensible authentication protocol (EAP) exchange for no clear reason. A deep analysis on the STA might reveal that its certificate has expired, but this may require the end user opening a support case, which is handled by a network administrator who has no access to the client logs and must run a large series of diagnostics.

Another example is a set of STAs connecting to the 2.4 GHz radio of an AP (instead of the 5 GHz radio) while the 5 GHz radio is available. The STAs may be set to prefer 5 GHz over 2.4 GHz, and the AP's 5 GHz radio broadcast SSID shows that the parameters are same as the SSID on 2.4 GHz. Access to the STA logs might reveal that the AP's 5 GHz radio is not responding to its messages, revealing a frozen transmit (TX) condition on the AP radio. But here again, the network administrator does not have access to the STA logs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a STA transmitting encrypted diagnostic data to an AP, according to one embodiment.

FIG. 2 is a flowchart for securely transmitting diagnostic data related to a failed onboarding attempt to an AP, according to one embodiment.

FIG. 3 is a flowchart for renewing an expiring LTK, according to one embodiment.

FIG. 4 is a flowchart for transmitting unsecured diagnostic data related to a failed onboarding attempt to an AP, according to one embodiment.

FIG. 5 is a chart for defining a diagnostic element in a frame, according to one embodiment.

FIG. 6 is a chart for defining a category and subcategory of a diagnostic element in a frame, according to one embodiment.

FIG. 7 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a station that includes one or more memories and one or more processors communicatively coupled to the one or more memories, wherein the one or more processors are configured to, individually or collectively, perform operations including detecting an issue that prevents the STA from onboarding with an access point (AP), securely transmitting, after detecting the issue, diagnostic data from the STA to the AP where the diagnostic data is encrypted using a key.

One embodiment presented in this disclosure is a method that includes providing a key to a station (STA), detecting, at the STA, an issue that prevents the STA from onboarding with an AP, and securely transmitting, after detecting the issue, diagnostic data from the STA to the AP, wherein the diagnostic data is encrypted using the key.

One embodiment presented in this disclosure is an AP that includes one or more memories and one or more processors communicatively coupled to the one or more memories, wherein the one or more processors are configured to, individually or collectively, perform operations determining that a STA is attempting to onboard to the AP and receiving, before the STA has on boarded to the AP, diagnostic data from the STA indicating that an issue has prevented the STA from onboarding where the diagnostic data is encrypted using a key.

### Example Embodiments

Embodiments herein describe techniques for securely transmitting diagnostic data between a STA and an AP before the STA has successfully been on boarded at the AP. After a STA has been on boarded by (e.g., has associated with) an AP, the STA and AP have exchanged keys which make secure communication possible; however, if onboarding fails (which happens often), there was previously no secure way for the STA to provide diagnostic data regarding the failure to the AP. In the embodiments herein, the STA can use a long-term key (LTK) to encrypt diagnostic data transmitted to the AP when the STA has not been on boarded by the AP. This LTK can be provided to the STA several different ways such as when the STA was provisioned to connect to a service set identifier (SSID) supported by the AP, or the STA may have previously associated with the SSID (e.g., by connecting to the same or another AP supporting the SSID during a previous session) and received or generated the LTK.

Now, when the STA detects an issue that prevents it from completing the onboarding process with an AP supporting the SSID, the STA can use the LTK to encrypt and transmit diagnostic data (e.g., in a control or management frame) related to the issue to the AP. Any nefarious actors which may be listening to the wireless traffic will not be able to obtain the diagnostic data, which can contain sensitive private information regarding the STA. However, the AP can decrypt the diagnostic data and take an action such as attempt to address the issue so the STA can complete the onboarding process, or can report the issue to a wireless LAN controller (WLC) or a network administrator to address the issue. By securely transmitting the diagnostic data, the AP (or network) gets the benefit of information that is known only to the STA, while the STA gets the benefit of protecting potential private information in the diagnostic data.

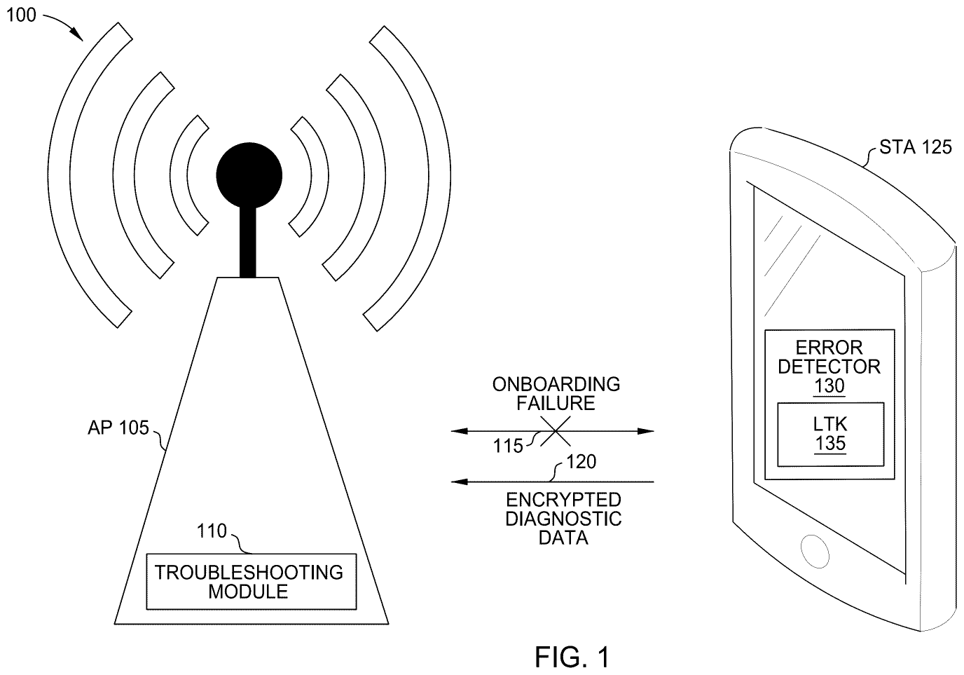

FIG. 1 illustrates a system 100 of a STA 125 transmitting encrypted diagnostic data 120 to an AP 105, according to one embodiment. The STA 125 (e.g., a laptop, desktop, mobile phone, tablet, IoT device, etc.) includes an error detector 130 (e.g., a software or firmware module) that can generate diagnostic data when an onboarding process fails. As shown in FIG. 1, the STA 125 is attempting to join an SSID hosted by the AP 105. However, the STA 125 experiences an onboarding failure 115 where the onboarding process cannot complete.

The Wi-Fi onboarding process can include multiple different phase. During a scanning and network Selection, the STA scans for available networks by sending probe requests. APs in range respond with probe response frames containing information like the SSID and Basic Service Set Identifier (BSSID). The user selects the desired network (e.g., SSID) from the list of available networks presented on their device. During an authentication phase, the STA initiates the authentication process, e.g., using a pre-shared key (PSK) or password in WPA3-Personal networks. The STA transmits an authentication request to the AP which in turn validates the provided credentials and responds with an authentication response.

Upon successful authentication, the onboarding process moves to an association phase where the STA associates with the AP. This registers the STA with the AP and allows it to communicate on the network. Further, a unique Association ID (AID) is assigned to the STA.

During a network access phase, the Dynamic Host Configuration Protocol (DHCP) can be used where the STA requests an IP address from the network. Once the IP address is obtained, the STA can access network resources and communicate with the outside world using the network. However, this is just one example of the phases and functions of the onboarding process. Other types of onboarding processes (e.g., for Enterprise networks) may differ. The embodiments herein are not limited to any type of onboarding process, and can apply to any process where a STA and AP may want to transmit diagnostic information before a secure connection (or session keys) has been established.

Further, the embodiments herein are not limited to any particular type of issue or failure that can occur during the onboarding process. Some non-limiting examples of issues or failures can be expired certificates, software issues, hardware issues, network connection issues, and the like. These issues and failures can occur during any of the phases of the onboarding process.

The error detector 130 can identify when the onboarding process has failed (e.g., the onboarding failure 115) and capture diagnostic data related to the failure or issue. For example, the diagnostic data can indicate what phase of the onboarding process failed (e.g., authentication phase or during layer 2 (L2) onboarding) or more detailed information (e.g., failed during radio initialization). In one embodiment, the diagnostic data can be formatted into one or more diagnostic elements that are transmitted in a management frame. For example, the diagnostic element can be an information element in a management frame (e.g., deauthentication (deauth) or deassociation (deassoc) frames). Or a new type of frame can be defined in a wireless standard (e.g., IEEE 802.11) for securely transmitting the diagnostic data.

The AP 105 includes a troubleshooting module 110 (e.g., a software or firmware module) that receives and decrypts the encrypted diagnostic data 120. The troubleshooting module 110 can then take an action based on the diagnostic data. In one embodiment, the troubleshooting module 110 reports the diagnostic data to a network administrator or WLC. Additionally or alternatively, the troubleshooting module 110 can perform a troubleshooting action on the AP such as resetting a radio if the diagnostic data indicates the failure occurred during radio initialization. In some embodiments, the troubleshooting module 110 can perform an action so that the onboarding process can continue. For example, the troubleshooting module 110 can perform an action in real-time so that an issue that was preventing the STA 125 from completing the onboarding process has been resolved so that the STA 125 can continue with the process.

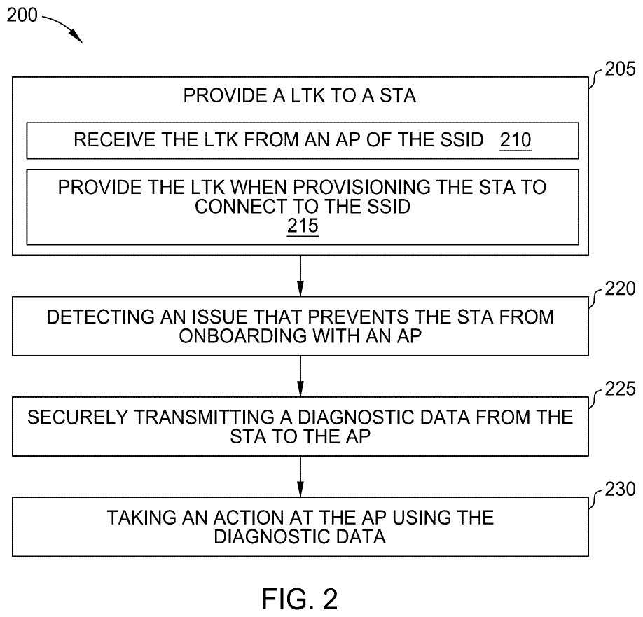

FIG. 2 is a flowchart of a method 200 for securely transmitting a diagnostic element related to a failed onboarding attempt to an AP, according to one embodiment. At block 205, the system provides a LTK to the STA that the STA can use to encrypt diagnostic data. In one embodiment, the LTK is used only to encrypt diagnostic data, and no other types of data that are transmitted between the STA and an AP. This may improve the security so that if a nefarious actor does obtain the LTK, it can at most transmit false or counterfeit diagnostic data, instead of more sensitive data.

There are multiple ways the STA can obtain a LTK. As illustrated in sub-block 210, the STA can receive the LTK from an AP of the SSID. For example, the STA may have previously successfully on boarded with the AP (or another AP of the SSID). After the Wi-Fi session is established, the AP can then provide the STA with the LTK which it can then use to transmit diagnostic data if later onboarding attempts fail (as discussed below). In one embodiment, the AP delivers the LTK to the STA during a 4-way handshake (for example, during M3 of the handshake) or the equivalent in FILS. Or the AP may send a protected action frame to the STA that provisions the LTK. The STA then stores the LTK in its SSID profile.

In one embodiment, the LTK is a SSID-wide key or is an extended service set (ESS)-wide key. That is, any STA that connects to the SSID or ESS may be given the same LTK, and use that LTK to transmit encrypted diagnostic data. Alternatively, the LTK may be specific to a particular STA, or a particular AP. For example, the AP make give the same LTK to any STA it on boards, or the AP may provide a unique LTK to each STA.

In another embodiment, the STA generates the LTK and then provides the LTK (or a key for decrypting data encrypted by the LTK) to the AP (e.g., during step M4 of the 4-way handshake or FILS equivalent). The AP then stores the key. In addition, the AP can use a backend to forward the key received from the STA to the other APs supporting the SSID or ESS. Or the key can be provided to a WLC, where the WLC may be tasked with decrypting encrypted diagnostic data received from the STAs.

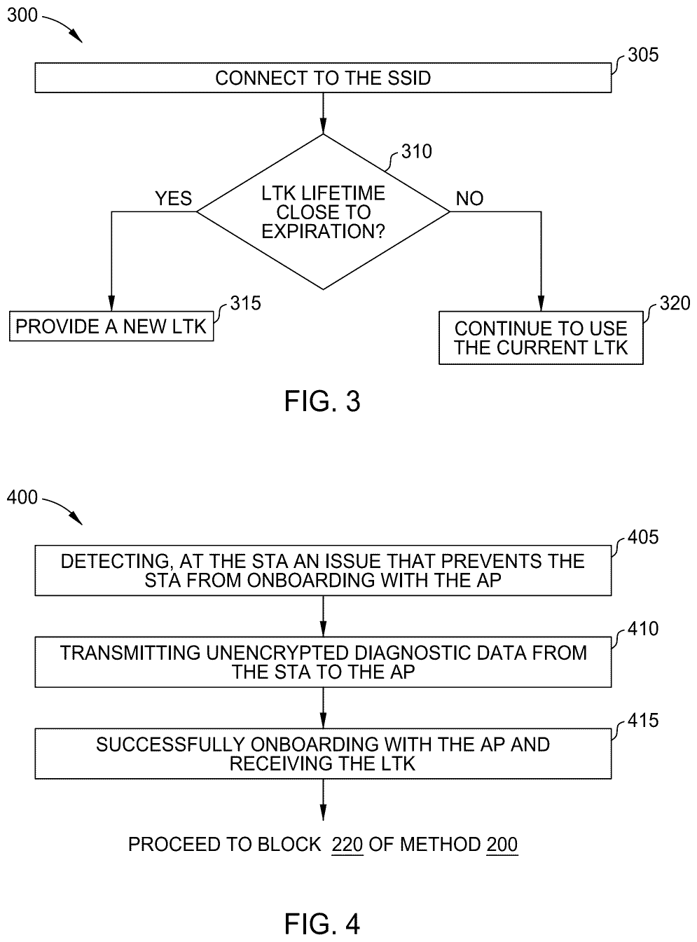

In any of these embodiments, the LTK may have a defined lifetime, after which, the LTK expires and the system has to provide a new LTK to the STA. This is discussed in more detail in FIG. 3.

Another way to provide the LTK to the STA is illustrated in sub-block 215 where a network administrator provides the LTK when provisioning the STA to connect to the SSID. For example, a network administrator can provision the STA to connect to an enterprise network (e.g., using mobile device management (MDM)), which can include configuring the device with the necessary network settings, security credentials, and often, management policies, to allow it to access and interact with the enterprise's resources. The LTK can be one of the security credentials provided to the STA. In this embodiment, the LTK can be provided to the STA without the STA having to already successfully join the SSID.

At block 220, the STA (e.g., the error detector 130 in FIG. 1) detects an issue that prevents the STA from onboarding with the AP. This can include any of the issues discussed above, which can occur at any of the phases of the onboarding process.

Moreover, the issue may not have caused the STA to fail the onboarding process, but rather the STA may have paused the onboarding process (because it cannot continue) and sent the diagnostic data in hopes the AP can resolve the issue. However, in other embodiments, the STA may have stopped the onboarding process.

At block 225, the STA securely transmits diagnostic data related to the issue with the onboarding process to the AP. That is, the diagnostic data is encrypted using the LTK so that the transmission can be decrypted only by an authorized AP or WLC. Thus, if a nefarious actor intercepts the wireless transmission, it cannot decrypt the diagnostic data.

Moreover, the AP may prompt the STA to transmit the diagnostic data at block 225, rather than the STA transmitting the diagnostic data on its own (e.g., in response to detecting the issue at block 220). For example, if the AP notices the STA has started the onboarding process, but did not complete it, the AP can transmit a frame to the STA requesting the STA to securely transmit any diagnostic data it has to the AP.

Moreover, the STA may request diagnostic data from the AP (or the AP may send diagnostic data on its own to the STA). The LTK can be used by both the AP and the STA to securely transmit diagnostic data before onboarding has been completed.

At block 230, the AP takes an action using the diagnostic data, such as reporting the diagnostic data to the WLC or network administrator, or performing a troubleshooting action on the AP. In one embodiment, the AP may forward the diagnostic data at intervals, or wait until the AP has a threshold amount of diagnostic data (e.g., aggregate the diagnostic data). Or the AP may immediately forward the diagnostic data as it receives it, but if the AP receives the same type of diagnostic data over a short period of time (or a threshold amount of the same type of diagnostic data), it may send an alert to the system administrator or send the diagnostic data with a higher priority. In this manner, the AP can perform some processing or analysis on the diagnostic data before forwarding the data to the WLC or network administrator.

Moreover, the AP can perform troubleshooting using the diagnostic data (e.g., using the troubleshooting module 110 in FIG. 1). In that case, the AP can attempt to diagnosis the problem or issue using the diagnostic data and perform a corrective action (e.g., resetting a hardware unit, testing interfaces, changing the capabilities being advertised, etc.). Doing so may enable the STA to continue the onboarding process (or restart the onboarding process).

In one embodiment, the AP uses the LTK (or its own LTK) to transmit a response to the STA. For example, the AP may perform an action based on the diagnostic data and then inform the STA what action was performed, or indicate to the STA it should restart or continue the onboarding process. As such, the AP can use an LTK to securely transmit a reply to the STA.

Moreover, while the method 200 describes using the LTK to securely transmit diagnostic data during onboarding it is not limited to such. For example, the STA may use the LTK to securely transmit diagnostic data when it disconnects from the AP (e.g., off boards). For example, the STA may encounter slow network speeds with the AP and instead switch to a different communication network (e.g., 5G or LTE). Even though the AP could use session keys to securely transmit diagnostic data indicating the STA is disconnecting because of poor data speeds, it might instead use the LTK.

In addition, the LTK could also be used as part of pre-association security negotiation (PASN) which is a technique that allows for the establishment of a secure connection, including authentication and key exchange, before a device fully associates with a Wi-Fi network. The LTK exchange could be used to secure initial communication without the STA fully associating to the AP. For example, the LTK could be used in PASN to perform a site survey where the STAs use the LTK to provide encrypted telemetry data to the APs at the site.

FIG. 3 is a flowchart of a method 300 for renewing an expiring LTK, according to one embodiment. At block 305, the STA connects to the SSID. The method 300 assumes that the STA has already received a LTK using any of the embodiments discussed above in the method 200.

At block 310, the STA, AP, or WLC determines whether the LTK lifetime is close to expiration. For example, unlike session keys which are valid only for a Wi-Fi session (or expire soon after the Wi-Fi session is terminated), the LTK lifetime can be independent of (i.e., not tied to) a duration of a session. For example, the LTK lifetime (e.g., two weeks) may be much longer than a typical Wi-Fi session which is typically less than a day for mobile STAs.

The STA, AP, or WLC may determine each time the STA starts a new session with the SSID or ESS (e.g., each time the STA on boards with an AP that supports the SSID or ESS) whether the LTK is about to expire (e.g., if the LTK expires in less than two days).

If the LTK lifetime is close to its expiration, the method 300 proceeds to block 215 where a new LTK is provided to the STA (or the LTK is renewed). This can be performed using any of the embodiments above, such as the AP transmitting a new LTK to the STA, or a STA generating its own LTK and providing that LTK to the AP. If the LTK is a SSID-wide or ESS-wide LTK, then the AP may generate a new LTK a few days before the old LTK expires and provide the new LTK as each STA reconnects to the SSID or ESS. In this manner, a STA can get a new LTK before the old LTK expires (or renew the old LTK) so the STA can continue to securely transmit diagnostic data to the AP if future on boarding attempts fail.

In addition, when generating a new LTK, the AP or STA can provide a future start date when the LTK is valid while another key provisioned previously is the current valid key. In addition, the actor who generates the key can indicate the lifetime of the LTK (or the lifetime may be set by a wireless standard).

However, if the LTK lifetime is not close to expiration, the method 300 proceeds to block 320 where the STA continues to use the current LTK to securely transmit diagnostic data when encountering issues during on boarding.

FIG. 4 is a flowchart of a method 400 for transmitting an unsecured diagnostic element related to a failed onboarding attempt to an AP, according to one embodiment. That is, unlike in FIG. 2 where a LTK is used to securely transmit diagnostic data, in method 400 a STA transmits diagnostic data in the open (or in the clear) where the data is not encrypted. For example, the method 400 may be performed if the STA has not received a LTK because the STA has not previously successfully connected to the SSID or because the STA was not provisioned to connect to the SSID/ESS. Or the method 400 may be used if the STA had a LTK but its lifetime has expired without the STA receiving a new LTK (e.g., the STA went too long before re-associating with the SSID).

At block 405, the STA detects an issue that prevents the STA from onboarding with the AP. These issues can be any of the same issues discussed above at block 220 of the method 200.

At block 410, since the STA does not have a valid LTK, the STA transmits unencrypted diagnostic data from the STA to the AP.

At block 415, it is assumed the issue has been resolved (e.g., by the AP, WLC, or a network administrator performing an action based on the diagnostic data) and the STA successfully on boards with the AP. The AP can then provide the TLK to the STA, or the STA can generate its own LTK and send the LTK (or a corresponding key for decrypting its data) to the AP.

The method 400 can then proceed to block 220 of the method 200 where if the STA has future issues when on boarding at the SSID or ESS, it can use the TLK to securely transmit encrypted diagnostic data. Thus, method 400 describes scenarios where the STA may temporally transmit unsecured diagnostic data which can help the AP or system administrator to resolve any issues. Once resolved, the STA can successfully connect with the AP and then receive or generate a LTK that can be used in the future.

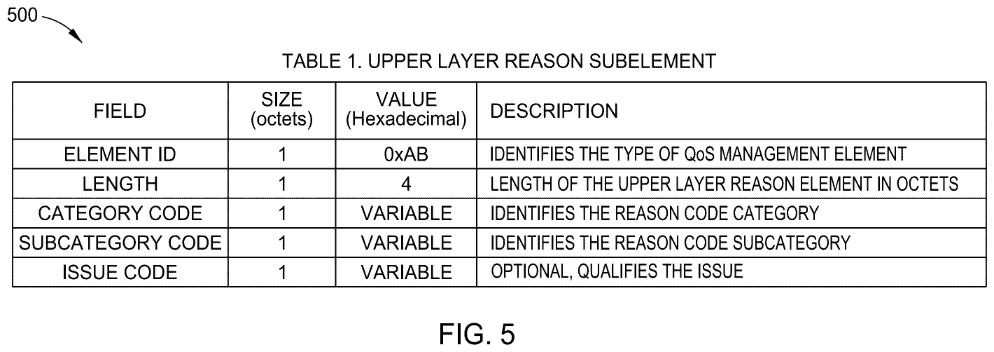

FIG. 5 is a chart 500 for defining a diagnostic element in a frame, according to one embodiment. In one embodiment, the diagnostic data may be formatted as a diagnostic element in a frame (e.g., an information element in a deass or deauth frame). While the diagnostic data could be textual (e.g., a textual description of the issue), an information element in a frame (or even several information elements concatenated together) has limited space (e.g., 256 bytes). As such, codes may be used in the diagnostic element.

Chart 500 illustrates that a frame can include an upper layer reason sub element as shown. The sub element can include an element ID that identifies the type of quality of service (QoS) management element, a length indicating the length of the upper layer reason element in octets, a category code which identifies the reason code category of the issue, a subcategory code that identifies a subcategory for the issue, and an issue code which qualifies the issue. However, the format for this sub element as shown in chart 500 is just one suitable format example.

As illustrated, the format in chart 500 assigns a category and a subcategory to the issue or problem encountered by the STA. These categories and subcategories can be predefined so that when the STA encounters an issue, it can assign the issue into one of the categories and subcategories.

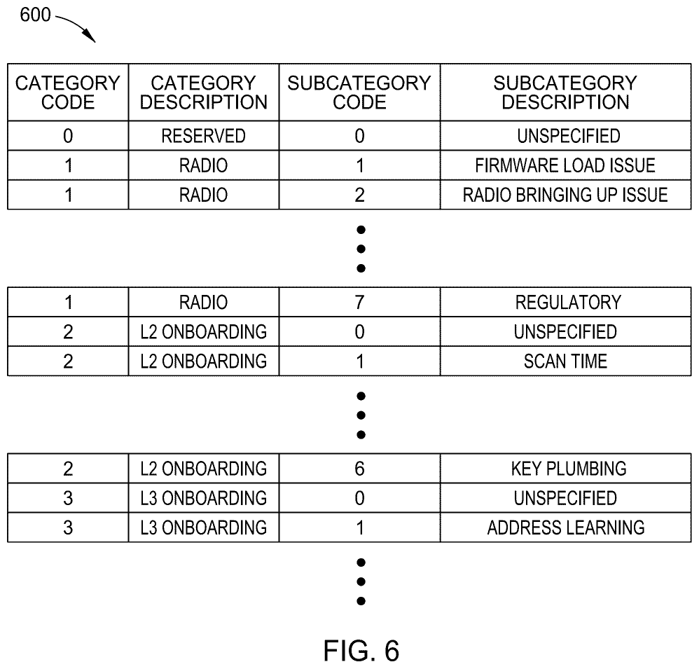

Examples of categories and subcategories are illustrated in FIG. 6. Chart 600 illustrates different category codes on the leftmost column and what these code describe in the second leftmost column. That is, Code 1 means there was an issue with the radio, Code 2 means there was an issue with L2 Onboarding, Code 3 means there was an issue with L3 Onboarding, etc.

The second from right column illustrates different subcategory codes while the rightmost column describes the subcategory codes. That is, Subcategory Code 1 under Code 1 means there was an issue with the firmware load of the radio, Subcategory Code 2 under Code 1 means the radio brought up the issue, and Subcategory Code 7 under Code 1 means there was regulatory issue with the radio. The subcategory codes can then repeat, but for a different category code. For example, Subcategory Code 1 under Code 2 means there was an issue with the scan time when performing L2 Onboarding and Subcategory Code 6 under Code 2 means there was a key plumbing issue when performing L2 Onboarding. Other subcategories can be defined for category code 3 (e.g., L2 Onboarding), and so forth. Having predefined categories and subcategories permits the STA and AP to efficiently transmit diagnostic data in limited space (e.g., in an information element of a management frame).

However, the formats illustrated in FIG. 5 and the category/subcategory definitions in FIG. 6 are just examples. In other embodiments, the diagnostic element may only have category codes (e.g., no sub-category codes), or can include sub-sub-category codes. Moreover, the format can include a mix of one or more category codes and a textual description of the issue.

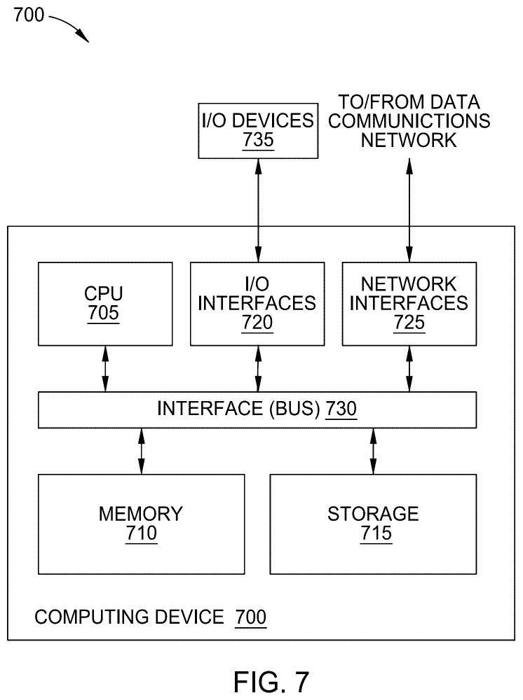

FIG. 7 depicts an example computing device configured to perform various aspects of the present disclosure, according to one embodiment. Although depicted as a physical device, in embodiments, the computing device 700 may be implemented using virtual device(s), and/or across a number of devices (e.g., in a cloud environment). In one embodiment, the computing device 700 corresponds to a network device (e.g., a computing system), such as the APs or the STAs (e.g., user devices) mentioned above.

As illustrated, the computing device 700 includes a CPU 705 (one or more processors), memory 710 (or memories), storage 715, a network interface 725, and one or more input/output (I/O) interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

The memory 710 can include software programs or application for transmitting secure diagnostic data as discussed above in FIGS. 1-6. For example, the device 700 can be a STA transmitting secure diagnostic data to an AP or an AP transmitting secure diagnostic data to a STA. Although shown as residing in memory 710, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A station (STA) comprising:
one or more memories; and
one or more processors communicatively coupled to the one or more memories, wherein the one or more processors are configured to, individually or collectively, perform operations comprising:
detecting an issue that prevents the STA from onboarding with an access point (AP); and
securely transmitting, after detecting the issue, diagnostic data from the STA to the AP, wherein the diagnostic data is encrypted using a key.

2. The STA of claim 1, wherein the key is provided to the STA at least one of: when provisioning the STA to connect to a SSID associated with the AP, or when the STA previously connected to the SSID.

3. The STA of claim 2, wherein the operation further comprises:
receiving the key from at least one AP associated with the SSID when the STA previously connected to the SSID.

4. The STA of claim 2, wherein the operation further comprises:
generating the key at the STA; and
transmitting the key to at least one AP associated with the SSID when the STA previously connected to the SSID.

5. The STA of claim 1, wherein a lifetime of the key is not tied to a lifetime of a session between the STA and the AP.

6. The STA of claim 1, wherein the diagnostic data is included in a deauthentication or deassociation frame.

7. The STA of claim 1, wherein the operation further comprises:
receiving a request at the STA from the AP for diagnostic information while the STA is not associated with the AP; and
transmitting the diagnostic information to the AP, wherein the diagnostic information is encrypted using the key.

8. The STA of claim 1, wherein the diagnostic data is formatted in a diagnostic element that indicates a phase of onboarding where the issue was encountered and a sub-category associated with the phase.

9. The STA of claim 8, wherein the operation further comprises, before detecting the issue:
detecting, at the STA, another issue that prevents the STA from onboarding with the AP; and
transmitting, in response to detecting the issue, additional diagnostic data from the STA to the AP, wherein the additional diagnostic data is unencrypted.

10. The STA of claim 1, wherein the key is SSID-wide key that is used by every STA that sends diagnostic information to a SSID associated with the AP.

11. A method comprising:
providing a key to a station (STA);
detecting, at the STA, an issue that prevents the STA from onboarding with an access point (AP); and
securely transmitting, after detecting the issue, diagnostic data from the STA to the AP, wherein the diagnostic data is encrypted using the key.

12. The method of claim 11, wherein the key is provided to the STA at least one of: when provisioning the STA to connect to a SSID associated with the AP, or when the STA previously connected to the SSID.

13. The method of claim 12, wherein providing the key further comprises:
receiving the key from at least one AP associated with the SSID when the STA previously connected to the SSID.

14. The method of claim 12, wherein providing the key further comprises:
generating the key at the STA; and
transmitting the key to at least one AP associated with the SSID when the STA previously connected to the SSID.

15. The method of claim 11, wherein a lifetime of the key is not tied to a lifetime of a session between the STA and the AP.

16. The method of claim 15, further comprising:
determining a lifetime of the key is going to expire; and
providing a new key to the STA after the STA successfully associates with the AP.

17. The method of claim 11, wherein the diagnostic data is included in a deauthentication or deassociation frame.

18. The method of claim 11, further comprising:
receiving a request at the STA from the AP for diagnostic information while the STA is not associated with the AP; and
transmitting the diagnostic information to the AP, wherein the diagnostic information is encrypted using the key.

19. An access point (AP) comprising:
one or more memories; and
one or more processors communicatively coupled to the one or more memories, wherein the one or more processors are configured to, individually or collectively, perform operations comprising:
determining that a STA is attempting to onboard to the AP; and
receiving, before the STA has on boarded to the AP, diagnostic data from the STA indicating that an issue has prevented the STA from onboarding, wherein the diagnostic data is encrypted using a key.

20. The AP of claim 19, wherein operation further comprises:
transmitting the key to the STA when the STA previously successfully on boarded to the AP.
